(19) United States
(12) Patent Application Publication
(10) Pub. No.: US 2025/0227450 A1
(43) Pub. Date: Jul. 10, 2025

(54) METHOD AND APPARATUS FOR PROVIDING PRIORITY SERVICE TO MESSAGING SERVICE IN A WIRELESS COMMUNICATION SYSTEM

(71) Applicant: Samsung Electronics Co., Ltd., Suwon-si (KR)

(72) Inventors: Ashok Kumar NAYAK, Bangalore (IN); Lalith KUMAR, Bangalore (IN)

(21) Appl. No.: 19/008,978

(22) Filed: Jan. 3, 2025

(30) Foreign Application Priority Data
Jan. 5, 2024 (IN) 202441001129
Dec. 24, 2024 (IN) 2024 41001129

(51) Int. Cl. H04W 8/04; H04W 4/12

(52) U.S. Cl. CPC H04W 8/04; H04W 4/12

(57) ABSTRACT

A method performed by a network entity in a wireless communication system is provided. The method includes querying, by the network entity, at least one of a Unified Data Management (UDM) entity and a Home Subscriber Server (HSS) entity to determine whether an Multimedia Priority Service (MPS) for the messaging service is enabled, and adding, by the network entity, a message priority header in response to determining that the MPS for the messaging service is enabled.

### CROSS-REFERENCE TO RELATED APPLICATION(S)

This application is based on and claims priority under 35 U.S.C. § 119(a) of an Indian Provisional patent application No. 202441001129, filed on Jan. 5, 2024, in the Indian Intellectual Property Office, and of an Indian Complete patent application No. 202441001129, filed on Dec. 24, 2024, in the Indian Intellectual Property Office, the disclosure of each of which is incorporated by reference herein in its entirety.

### BACKGROUND

### 1. Technical Field

The disclosure relates to wireless communication networks. More particularly, the disclosure relates to systems and methods for ensuring that a fifth generation (5G) system is able to provide Multimedia Priority Service (MPS) to specific services (such as, but not limited to, Short Message Service (SMS) over 5G System (5 GS) and Evolved Packet System (EPS)).

### 2. Description of Related Art

5G mobile communication technologies define broad frequency bands such that high transmission rates and new services are possible, and can be implemented not only in “Sub 6 GHz” bands such as 3.5 GHZ, but also in “Above 6 GHz” bands referred to as mmWave including 28 GHz and 39 GHz. In addition, it has been considered to implement sixth generation (6G) mobile communication technologies (referred to as Beyond 5G systems) in terahertz (TH2) bands (e.g., 95 GHz to 3 THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive multiple input-multiple output (MIMO) for mitigating radio-wave path loss and increasing radio-wave transmission distances in mmWave, supporting numerologies (e.g., operating multiple subcarrier spacings) for efficiently utilizing mmWave resources and dynamic operation of slot formats, initial access technologies for supporting multi-beam transmission and broadbands, definition and operation of BandWidth Part (BWP), new channel coding methods such as a Low Density Parity Check (LDPC) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as Vehicle-to-everything (V2X) for aiding driving determination by autonomous vehicles based on information regarding positions and states of vehicles transmitted by the vehicles and for enhancing user convenience, New Radio Unlicensed (NR-U) aimed at system operations conforming to various regulation-related requirements in unlicensed bands, new radio (NR) user equipment (UE) Power Saving, Non-Terrestrial Network (NTN) which is UE-satellite direct communication for providing coverage in an area in which communication with terrestrial networks is unavailable, and positioning.

Moreover, there has been ongoing standardization in air interface architecture/protocol regarding technologies such as Industrial Internet of Things (IIoT) for supporting new services through interworking and convergence with other industries, Integrated Access and Backhaul (IAB) for providing a node for network service area expansion by supporting a wireless backhaul link and an access link in an integrated manner, mobility enhancement including conditional handover and Dual Active Protocol Stack (DAPS) handover, and two-step random access for simplifying random access procedures (2-step random access channel (RACH) for NR). There also has been ongoing standardization in system architecture/service regarding a 5G baseline architecture (e.g., service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with extended Reality (XR) for efficiently supporting Augmented Reality (AR), Virtual Reality (VR), Mixed Reality (MR) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using Orbital Angular Momentum (OAM), and Reconfigurable Intelligent Surface (RIS), but also full-duplex technology for increasing frequency efficiency of 6G mobile communication technologies and improving system networks, AI-based communication technology for implementing system optimization by utilizing satellites and Artificial Intelligence (AI) from the design stage and internalizing end-to-end AI support functions, and next-generation distributed computing technology for implementing services at levels of complexity exceeding the limit of UE operation capability by utilizing ultra-high-performance communication and computing resources.

The 3rd Generation Partnership Project (3GPP) technical specification (TS) 23.501 clause 5.22.1, “Subscription-related Priority Mechanisms include the ability to prioritize flows based on subscription information, including the prioritization of Radio Resource Control (RRC) Connection Establishment based on Unified Access Control mechanisms and the establishment of prioritized Quality of service (QOS) Flows”, where “including” refers to examples, and what follows is not to be interpreted as a complete set of uses. A User Equipment (UE) that has an Access Identity of 1 (MPS) (for example) through a Universal Subscriber Identity Module (USIM) or other means (i.e., registration) will use a priority establishment cause. This is specified in TS 24.501, clause 4.5.6, e.g., table 4.5.6.1. Here it states that when the UE is provided with an Access Identity 1 (MPS) it uses an RRC establishment cause with mps-Priority Access for any Access Category, and this is irrespective of service usage. Thus, service users with UEs with an MPS subscription, for example, will have the UE send a priority establishment cause for any interaction with the network, whether there is congestion or not, independent of the type of service request.

However, there are cases, for example, when the USIM may not have been provisioned with a priority subscription and the operator is in the process of adding to a Unified data management (UDM), an MPS subscription for some specific service SMS for this UE.

In addition, it may happen that even if the USIM has a pre-configuration of MPS subscription for the UE or for specific service like SMS, but for both Mobile Originated (MO) and Mobile Terminated (MT), a SMS does not get fully priority treatment, as there are some gaps in the system (or wireless network).

At present in the 3GPP, there is a requirement to provide priority treatment for the SMS over a Non Access Stratum (NAS) in 5GS or EPS. As described herein, there are some gaps in delivering both MO and MT SMS over the NAS in the 5GS or the EPS irrespective of whether the USIM is pre-configured with the MPS or not and MPS subscription is enabled or for the UE in an UDM/a Home Subscriber Server (HSS).

In a first example scenario, consider that a MO SMS over the NAS in the 5GS (i.e., USIM is already pre-configured with the MPS or MPS enabled info is present in the UE). The call then is as follows: UE→Access and Mobility Management Function (AMF)→Short Message Service Function (SMSF) (or SMSF entity)>Short Message Service (SMS) Interworking Mobile Switching Center (MSC) (SMS-IWMSC)→Service Center (SC). At present, based on the presence of priority establishment cause from the UE or the MPS subscription information from the UDM, the AMF adds a Message Priority header to the next Network Function (NF) SMSF, but there are gaps till it reaches the SC.

In a second example scenario, consider that MO SMS over NAS in EPS (i.e., USIM is already pre-configured with MPS or MPS enabled info is present in UE). The call then is as follows: UE→Mobility Management Entity (MME)>SMS-IWMSC→SC. At present based on the presence of priority establishment cause from UE or MPS subscription information from HSS, the MME does not provide treatment to SMSs till it reaches the SC.

In a third example scenario, consider that MT SMS over NAS in 5GS (i.e., USIM is already pre-configured with MPS or MPS enabled info is present in UE). The call then is as follows: SC→Short Message Service Gateway Mobile Switching Center (SMS-GMSC)→Internet Protocol Short Message Gateway (IP-SM-GW)→SMSF→AMF→UE. At present, there is no solution for giving priority treatment for MT SMS.

In a fourth example scenario, consider that MT SMS over the NAS in 5GS (i.e., USIM is already pre-configured with MPS or MPS enabled info is present in UE). The call then is as follows: SC→SMS-GMSC→IP-SM-GW→MME→UE. At present, there is no solution for giving priority treatment for MT SMS.

The above information is presented as background information only to assist with an understanding of the disclosure. No determination has been made, and no assertion is made, as to whether any of the above might be applicable as prior art with regard to the disclosure.

### SUMMARY

Aspects of the disclosure are to address at least the above-mentioned problems and/or disadvantages and to provide at least the advantages described below. Accordingly, an aspect of the disclosure is to provide systems and methods for ensuring that a 5G system is able to provide MPS to specific services (such as, but not limited to, SMS over 5GS and EPS).

Another aspect is to provide methods and systems for filling gaps, when the AMF adds a message priority header to the next NF SMSF, based on the presence of priority establishment cause from a UE or a MPS subscription information from an UDM and then all the subsequent NFs forward it until reaches a Service Center (SC).

Another aspect is to provide methods and systems for enabling a MME to provide treatment to the SMS, based on the presence of priority establishment cause from the UE or the MPS subscription information from the HSS and then all the subsequent NFs (like SMS-IWMSC) forward it until reaches the SC.

Another aspect is to provide methods and systems for giving priority treatment for MT SMS by NF like SMS-GMSC by retrieving MPS subscription information from HSS and then subsequent NFs (like IP-SM-GW and SMSF) forward till it reaches UE.

Another aspect is to disclose that the MPS for messaging/SMS is enabled in the UDM/HSS (for 5GS/EPS).

Another aspect is to disclose that a SMS-GMSC queries UDM/HSS and if received response with MPS for SMS is enabled then give priority treatment For MT SMS.

Another aspect is to disclose that the AMF/MME queries UDM/HSS and if received response with MPS for SMS is enabled then give priority treatment for MO SMS.

Another aspect is to disclose that AMF/MME page with priority by giving MPS for Message indication.

Additional aspects will be set forth in part in the description which follows and, in part, will be apparent from the description, or may be learned by practice of the presented embodiments.

In accordance with an aspect of the disclosure, a method performed by a network entity in a wireless network is provided. The method includes querying, by a network entity, at least one of a Unified Data Management (UDM) entity and a Home Subscriber Server (HSS) entity to determine whether a Multimedia Priority Service (MPS) for the messaging service is enabled, and adding, by the network entity, a message priority header in response to determining that the MPS for the messaging service is enabled.

In an embodiment, all subsequent NFs provide a priority to the messaging service based on the message priority header.

In another embodiment, all the subsequent NFs relay priority information by including the message priority header in at least one service-based interface.

In yet another embodiment, all the subsequent NFs comprises at least one of: an IP-SM-GW, a Short Message Service Function (SMSF) entity, and an AMF entity, and wherein the messaging service comprises a short message service (SMS).

In yet another embodiment, the network entity includes at least one of a Short Message Service Gateway Mobile Switching Center (SMS-GMSC) entity, Access and Mobility Management Function (AMF) entity, and a Mobility Management Entity (MME) entity.

In yet another embodiment, the SMS-GMSC entity queries the at least one of the UDM entity and the HSS entity to determine whether the MPS for the messaging service is enabled for mobile terminating messaging service.

In yet another embodiment, at least one of the AMF entity and the MME entity queries the at least one of: the UDM entity and the HSS entity to determine whether the MPS for the messaging service is enabled for mobile originating messaging service.

In yet another embodiment, when the network entity is a SMS-GMSC entity, querying the UDM entity to determine whether the MPS for the messaging service is enabled includes receiving, by the SMS-GMSC entity, a message from a SMS-SC entity, and querying, by the SMS-GMSC entity, the UDM entity to determine whether the MPS for the messaging service is enabled based on the message.

In yet another embodiment, the method includes adding, by the SMS-GMSC entity, the message priority header, while sending the message to a SMSF entity.

In yet another embodiment, the MPS for the messaging service is valid when at least one of: the MPS priority parameter is set, a User Equipment (UE) is allowed to use a messaging service, an MPS-EPS-Priority bit is set and a parameter indicate whether the MPS for messaging service is enabled in at least one of: the UDM entity and the HSS entity.

In yet another embodiment, when network entity is an AMF entity, adding the message priority header includes providing a priority messaging service indication in a paging message, when a User Equipment (UE) is in a connection management (CM)-IDLE state and the AMF entity needs to send a messaging service over Third Generation Partnership Project (3GPP) access, and if the UE indicates a paging cause indication for a priority messaging service feature is supported to a wireless network.

In yet another embodiment, the method includes supporting, by a next generation radio access network (NG-RAN), a paging cause indication for the priority messaging service, upon reception of a priority messaging service indication in a next generation application protocol (NGAP) paging message from the AMF entity. Further, the method includes including the priority messaging service indication in a Uu Paging message to the UE.

In yet another embodiment, the NG-RAN uses the priority messaging service indication, while the UE is in one of: a CM-IDLE, CM-CONNECTED state and an RRC-INACTIVE state.

In yet another embodiment, the network entity pages with priority by giving the MPS for a messaging service indication.

In accordance with another aspect of the disclosure, a method for providing a priority service to a messaging service in a wireless network is provided. The method includes receiving, by a NG-RAN, a priority messaging service indication in an NGAP paging message from an AMF entity. Further, the method includes supporting, by the NG-RAN, a paging cause indication for the priority messaging service, upon reception of the priority messaging service indication in the NGAP paging message from the AMF entity. Further, the method includes including, by the NG-RAN, the priority messaging service indication in a paging message to a User Equipment (UE).

In an embodiment, the NG-RAN uses the priority messaging service indication, while the UE is in one of: a CM-IDLE, CM-CONNECTED state and an RRC-INACTIVE state.

In accordance with another aspect of the disclosure, a network entity in a wireless communication system is provided. The network entity includes a transceiver, and at least one controller coupled with the transceiver, wherein the controller is configured to query at least one of: a Unified Data Management (UDM) entity and a Home Subscriber Server (HSS) entity to determine whether a Multimedia Priority Service (MPS) for a messaging service is enabled, and add a message priority header in response to determining that the MPS for the messaging service is enabled.

In accordance with another aspect of the disclosure, a method performed by a base station (BS) in a wireless communication system is provided. The method includes receiving, by the BS from an Access and Mobility Management Function (AMF) entity, a priority messaging service indication in a next generation application protocol (NGAP) paging message, supporting, by the BS, a paging cause indication for the priority messaging service, upon reception of the priority messaging service indication in the NGAP paging message from the AMF entity, and including, by the BS, the priority messaging service indication in a paging message to a user equipment (UE).

In accordance with another aspect of the disclosure, a base station (BS) is provided. The BS includes a transceiver and at least one controller coupled with the transceiver, wherein the controller is configured to receive, from an Access and Mobility Management Function (AMF) entity, an indication of a priority messaging service indication in a next generation application protocol (NGAP) paging message, support a paging cause indication for the priority messaging service, upon reception of the priority messaging service indication in the NGAP paging message from the AMF entity, include the priority messaging service indication in a paging message to a user equipment (UE).

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIGS. 1A and 1B illustrate a process of managing a MT SMS over a NAS in a 5GS, according to various embodiments of the disclosure;

FIG. 2 illustrates a process of managing a MO SMS over a NAS in a 5GS, according to an embodiment of the disclosure;

FIG. 3 illustrates various hardware components of a network entity, according to an embodiment of the disclosure;

FIG. 4 illustrates various hardware components of an NG-RAN, according to an embodiment of the disclosure;

FIG. 5 illustrates a flow chart of a method for providing a priority service to a messaging service in a wireless network by a network entity, according to an embodiment of the disclosure; and

FIG. 6 illustrates a flow chart of a method for providing a priority service to a messaging service in a wireless network by the NG-RAN, according to an embodiment of the disclosure.

Throughout the drawings, it should be noted that like reference numbers are used to depict the same or similar elements, features, and structures.

### DETAILED DESCRIPTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

The words/phrases “exemplary”, “example”, “illustration”, “in an instance”, “and the like”, “and so on”, “etc.”, “etcetera”, “e.g.,”, “i.e.,” are merely used herein to mean “serving as an example, instance, or illustration. Any embodiment or implementation of the present subject matter described herein using the words/phrases “exemplary”, “example”, “illustration”, “in an instance”, “and the like”, “and so on”, “etc.”, “etcetera”, “e.g.,”, “i.e.,” is not necessarily to be construed as preferred or advantageous over other embodiments.

Embodiments herein may be described and illustrated in terms of blocks which carry out a described function or functions. These blocks, which may be referred to herein as managers, units, modules, hardware components or the like, are physically implemented by analog and/or digital circuits such as logic gates, integrated circuits, microprocessors, microcontrollers, memory circuits, passive electronic components, active electronic components, optical components, hardwired circuits and the like, and may optionally be driven by a firmware. The circuits may, for example, be embodied in one or more semiconductor chips, or on substrate supports such as printed circuit boards and the like. The circuits constituting a block may be implemented by dedicated hardware, or by a processor (e.g., one or more programmed microprocessors and associated circuitry), or by a combination of dedicated hardware to perform some functions of the block and a processor to perform other functions of the block. Each block of the embodiments may be physically separated into two or more interacting and discrete blocks without departing from the scope of the disclosure. Likewise, the blocks of the embodiments may be physically combined into more complex blocks without departing from the scope of the disclosure.

It should be noted that elements in the drawings are illustrated for the purposes of this description and ease of understanding and may not have necessarily been drawn to scale. For example, the flowcharts/sequence diagrams illustrate the method in terms of the operations required for understanding of aspects of the embodiments as disclosed herein. Furthermore, in terms of the construction of the device, one or more components of the device may have been represented in the drawings by conventional symbols, and the drawings may show only those specific details that are pertinent to understanding the embodiments so as not to obscure the drawings with details that will be readily apparent to those of ordinary skill in the art having the benefit of the description herein. Furthermore, in terms of the system, one or more components/modules which comprise the system may have been represented in the drawings by conventional symbols, and the drawings may show only those specific details that are pertinent to understanding the embodiments so as not to obscure the drawings with details that will be readily apparent to those of ordinary skill in the art having the benefit of the description herein.

The accompanying drawings are used to help easily understand various technical features and it should be understood that the embodiments presented herein are not limited by the accompanying drawings. As such, the disclosure should be construed to extend to any modifications, equivalents, and substitutes in addition to those which are particularly set out in the accompanying drawings and the corresponding description. Usage of words such as first, second, third etc., to describe components/elements/steps/operations is for the purposes of this description and should not be construed as sequential ordering/placement/occurrence unless specified otherwise.

The embodiments herein achieve a method for providing a priority service to a messaging service in a wireless network. The method includes querying, by a network entity, at least one of: a UDM entity and a HSS to determine whether a Multimedia Priority Service (MPS) for the messaging service is enabled or not. Further, the method includes adding, by the network entity, a message priority header in response to determining that the MPS for the messaging service is enabled.

In an embodiment, for terminating SMS, the SMS-GMSC queries UDM/HSS to check whether MPS for SMS is enabled or not. If Enabled then SMS-GMSC will add Message priority header and then all the subsequent NFs will give priority. Similarly, for originating SMS, AMF/MME queries to check whether MPS for SMS is enabled or not. If Enabled then AMF/MME will add Message priority header and then all the subsequent NFs will give priority. Also for MT SMS, AMF/MME will page with priority by giving MPS for Message indication.

In another embodiment, if the MPS for messaging indication is set for the UE, the UDM may provide the parameter to the SMS-GMSC. If the MPS for Messaging indication from the UDM is set (enabled), the SMS-GMSC shall include a Message Priority header (or Diameter Routing Message Priority (DRMP)) to indicate priority information towards the SMSF.

In yet another embodiment, the AMF entity shall page with priority if the AMF entity receives an MT-SMS from the SMSF and has received an indication that MPS for the messaging is enabled for the UE in the UDM.

In yet another embodiment, the AMF shall page with priority if the AMF entity receives an MT-SMS from the SMSF with the message priority header value used for MPS for the messaging.

In yet another embodiment, when the AMF entity receives an MT-SMS from the SMSF entity and has either received an indication that MPS for the messaging is enabled for the UE from the UDM, or has received the MT-SMS with the message priority header value used for MPS, the AMF entity shall include the service priority value (RAN Paging Priority Information Element (IE) as per TS 38.413) appropriate for MPS for Messaging, in the Downlink NAS Transport message sent to the NG-RAN. NG RAN shall use the RAN Paging Priority received from the AMF to page the UE with priority when the UE is in RRC-INACTIVE state.

In yet another embodiment, when the AMF entity determines that the UE has the MPS for Messaging indication set (enabled) in the UE context, the AMF includes a Message Priority header to indicate priority information. Other NFs relay the priority information by including the Message Priority header in service-based interfaces, as specified in TS 29.500.

The embodiments herein achieve systems and methods for ensuring that a 5G system is able to provide MPS to specific services (such as, but not limited to, SMS over 5GS and EPS).

Embodiments herein disclose methods and systems for filling gaps, when the AMF adds a message Priority header to the next NF SMSF, based on the presence of priority establishment cause from UE or MPS subscription information from UDM and then all the subsequent NFs forward it until reaches SC. Embodiments herein disclose methods and systems for enabling the MME to provide treatment to the SMS, based on the presence of priority establishment cause from UE or MPS subscription information from HSS and then all the subsequent NFs forward it until reaches SC. Embodiments herein disclose methods and systems for giving priority treatment for MT SMS by NFs by retrieving MPS subscription information from HSS and then subsequent NFs forward till it reaches UE.

When the network is congested then, there is a need for giving priority treatment to services which is critical in nature similar to the emergency service, otherwise the services won't be received by user. Based on the proposed method, the messaging service or SMS needs to be prioritized, so as to improve the user experience.

It should be appreciated that the blocks in each flowchart and combinations of the flowcharts may be performed by one or more computer programs which include instructions. The entirety of the one or more computer programs may be stored in a single memory device or the one or more computer programs may be divided with different portions stored in different multiple memory devices.

Any of the functions or operations described herein can be processed by one processor or a combination of processors. The one processor or the combination of processors is circuitry performing processing and includes circuitry like an application processor (AP, e.g. a central processing unit (CPU)), a communication processor (CP, e.g., a modem), a graphics processing unit (GPU), a neural processing unit (NPU) (e.g., an artificial intelligence (AI) chip), a Wi-Fi chip, a Bluetooth® chip, a global positioning system (GPS) chip, a near field communication (NFC) chip, connectivity chips, a sensor controller, a touch controller, a finger-print sensor controller, a display driver integrated circuit (IC), an audio CODEC chip, a universal serial bus (USB) controller, a camera controller, an image processing IC, a microprocessor unit (MPU), a system on chip (SoC), an IC, or the like.

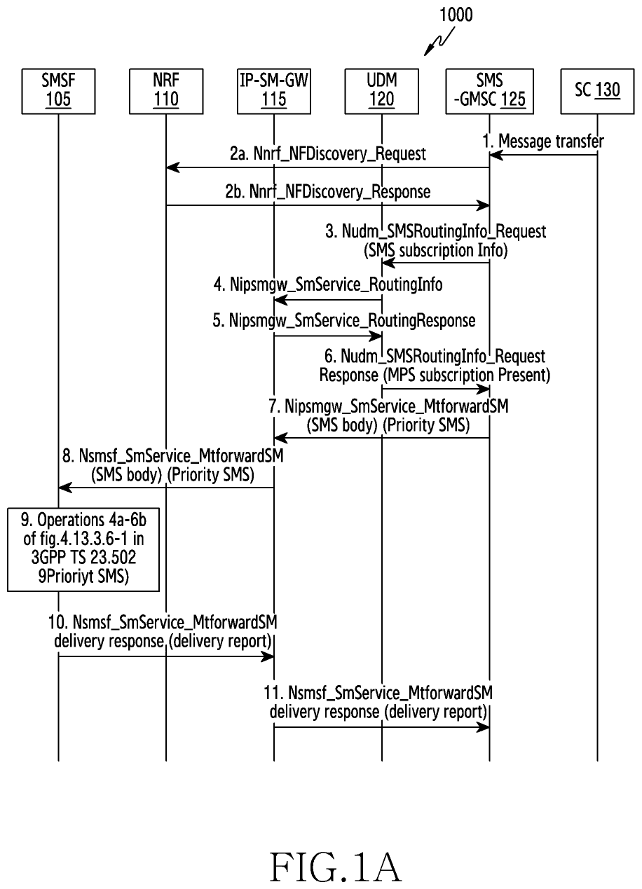

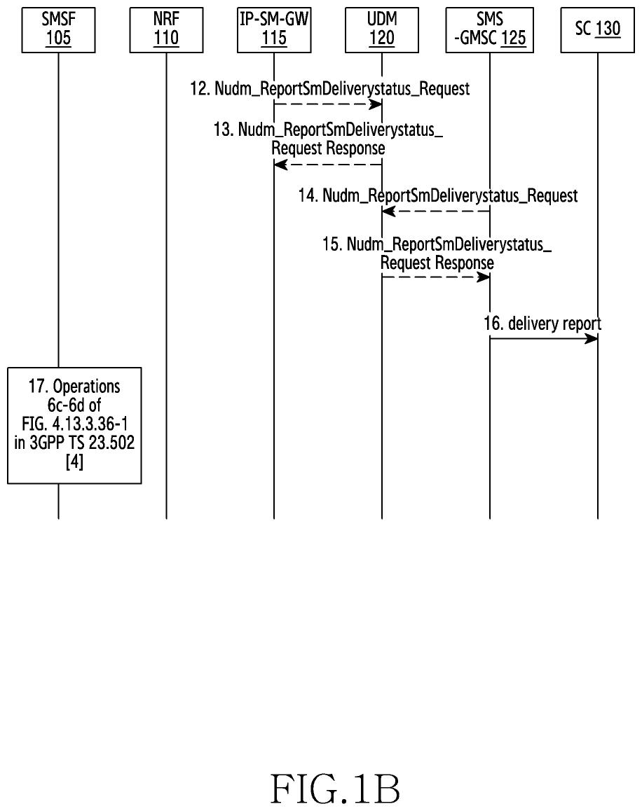

Referring now to the drawings, and more particularly to FIGS. 1A, 1B, and 2 to 6, where similar reference characters denote corresponding features consistently throughout the figures, there are shown embodiments.

### MT SMS Over NAS in 5GS:

To provide priority treatment for MT SMS over NAS, SMS-GMSC after receiving a message from SMS-SC queries the UDM and reads the subscription information. If MPS priority indication for SMS is present, then the SMS-GMSC shall add a Message priority header, while sending the message to the SMSF. The subsequent NFs (like IP-SM-GW, SMSF and AMF) shall give priority treatment based on the presence of Message Priority header until the message reaches the UE. If the UE is in CM-IDLE state and the AMF needs to send the SMS over 3GPP access, then the AMF shall provide a Priority SMS Indication in the Paging message, only if the UE indicates the Paging Cause Indication for Priority SMS feature is supported to the network. Upon reception of the Priority SMS Indication in NGAP Paging Message from AMF, the NG-RAN supporting Paging Cause Indication for Priority SMS should include the Priority SMS Indication in the Uu Paging message to the UE. The NG-RAN shall use this indication, while the UE is in CM-CONNECTED and RRC-INACTIVE state as well.

Here the MPS parameter can be configured at the subscription level which means any MO or MT service for the UE will be given priority treatment or at the SMS subscription only which means only applicable to SMS service. In an embodiment, MPS for Messaging indication Indicates whether the user has MPS for Messaging set (enabled)/cleared (disabled) as described in clause 5.16.5 of TS 23.501. This parameter is valid only when the MPS priority parameter is set and UE is allowed to use the SMS service. In another embodiment, the MPS for Messaging Indicates whether the user has MPS for Messaging set (enabled)/cleared (disabled) as described in clause C.1. This MPS for Messaging indication parameter is valid only when the MPS-EPS-Priority bit is set.

In this case, when the UE registers and provides SMS supported indication as per TS 23.501, in registration accept AMF will provide SMS allowed and MPS for SMS to UE which will help UE to provide priority establishment cause to NG-RAN, AMF while sending MO SMS.

### MT SMS Over NAS in EPS:

The concept is similar to the procedure proposed in 5GS with the below difference, AMF+SMSF is replaced with MME, and UDM is replaced with HSS.

FIGS. 1A and 1B illustrate the process of managing the MT SMS over a NAS in a 5GS in a wireless network 1000 according to various embodiments of the disclosure.

Referring to FIGS. 1A and 1B, in operation 1, the MT SMS interaction between a Service Center (SC) 130 and a SMS-GMSC (or SMS-GMSC entity) 125 follow the current procedure as defined in the 3GPP TS 23.040. In operations 2a, & 2b, the SMS-GMSC 125 should query a Network Repository Function (NRF) 110 to find a UDM instance that manages user subscriptions using a GPSI. In operation 3, the SMS-GMSC 125 invokes a Nudm_SmsRoutingInfo_Request (GPSI) to the UDM (or UDM entity) 120 to get the serving node information for the UE 145 and to download SMS subscription information or to know whether a subscriber is MPS enabled or MPS enabled for the SMS. To download SMS subscription info (information), either some indication can be present or at this operation or after operation 6, the SMS-GMSC 125 may send a Nudm_SDM_Get service operation to get response from the UDM 120 with the subscription information or the UDM 120 may inform whether the subscriber is MPS enabled or MPS enabled for the SMS. In operation 4, the UDM 120 shall check (or determine) the registration/reachability flags to determine the potential target nodes, e.g. SMSF (or SMSF entity) 105. For MT SM transfer via an IP-SM-GW 115, the UDM 120 shall invoke the Nipsmgw_SMService_RoutingInfo to provide the SMSF Instance Id to the IP-SM-GW 115. The address of the IP-SM-GW 115 to be contacted by the UDM 120 may be configured locally. In operation 5, the IP-SM-GW 115 shall send Nipsmgw_SMService_RoutingInfo response to the UDM 120.

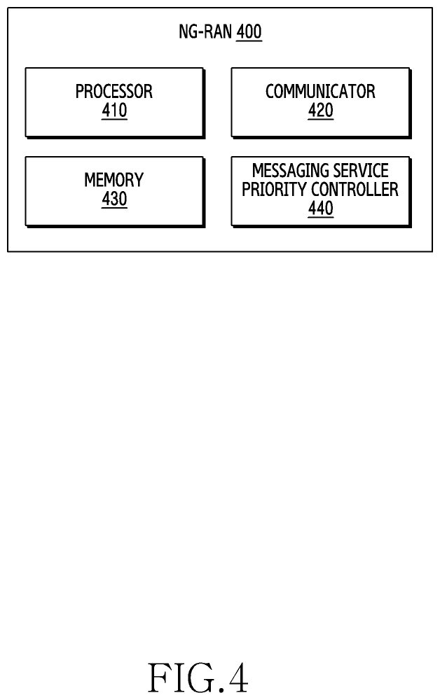

In operation 6, the UDM 120 responds to the SMS-GMSC 125 by sending Nudm_SmsRoutingInfo_Request response (including IP-SM-GW address) and provides SMS subscription information from which SMS-GMSC 125 finds the MPS subscription. In operation 7, the SMS-GMSC 125 forwards the SMS message to the IP-SM-GW 115 by invoking Nipsmgw_SMService_MtForwardSm service operation and adding message priority header. In operation 8, the IP-SM-GW 115 forwards the SMS message to the SMSF 105 by invoking Nsmsf_SMService_MtForwardSm service operation and forward the message priority header. In operation 9, the MT SMS over a NAS procedure between the SMSF 105, an AMF (AMF entity) 140 and the UE 145 is the same as in operations 4a to 6b of FIG. 4.13.3.6-1 of 3GPP TS 23.502 with presence of additional Message Priority header. After receiving this message priority header, if the UE 145 is in CM-IDLE and the SMS need to be sent over a 3GPP access, the AMF 140 shall provide a priority SMS indication to NG-RAN in a NGAP paging message only if the UE 145 indicates a paging cause indication for the priority SMS feature is supported to the network, which NG-RAN should use in Uu paging message. In operation 10, the SMSF 105 delivers a delivery report to the IP-SM-GW 115 by sending the Nsmsf_SMService_MtForwardSm response to the IP-SM-GW 115.

In operation 11, the IP-SM-GW 115 delivers the delivery report to the SMS-GMSC 125 by sending the Nipsmgw_SMService_MtForwardSm response to the SMS-GMSC 125. In operation 12, the IP-SM-GW 115 may report the SM-Delivery Status to the UDM 120 by invoking a Nudm_ReportSMDeliveryStatus_Request. In operation 13, the UDM 120 responses with Nudm_ReportSMDeliveryStatus_Request response to the IP-SM-GW 115. In operations 14-15, the SMS-GMSC 125 may report the SM-Delivery Status to the UDM 120 by invoking Nudm_ReportSMDeliveryStatus_Request and the UDM 120 shall ignore the information provided in this report.

In operation 16, the SMS-GMSC 125 delivers the delivery report to the SC 130 as defined in 3GPP TS 23.040. In operation 17, the MT SMS over the NAS procedure between the SMSF 105, the AMF 140 and the UE 145 is the same as in operations 6c to 6d of FIG. 4.13.3.6-1 of 3GPP TS 23.502.

If a Service-based Interface (SBI) is not supported between the SMS-GMSC 125, the IP-SM-GW 115 and the SMSF 105 then instead of the Message Priority header of HTTP/2 should be replaced with Session-Priority AVP of Diameter.

Here the MPS parameter can be configured at the subscription level which means any MO or MT service for the UE 145 will be given priority treatment or at the SMS subscription only which means only applicable to the SMS service. In this case, when the UE 145 registers and provides SMS supported indication as per TS 23.501, in the registration accept, the AMF 140 will provide SMS allowed and MPS for SMS to the UE 145 which will help the UE 145 to provide priority establishment cause to NG-RAN, the AMF 140 while sending MO SMS.

MO SMS over NAS in 5GS: TS 23.502 Clause 4.2.2.2 is addressing how the AMF 140 is adding Message Priority header to indicate priority information for the cases when AMF 140 receives establishment cause associated with priority services and didn't receive the establishment cause associated with priority services, but priority indication information is as part of as part of the access and mobility subscription data.

When the establishment cause is associated with the priority services (e.g. MPS, MCS), the AMF 140 includes the message priority header to indicate priority information. Other NFs relay the priority information by including the Message Priority header in service-based interfaces, as specified in TS 29.500.

If the AMF 140 receives a priority indication (e.g., MPS, MCX) as part of the Access and Mobility Subscription data, but the UE 145 did not provide an Establishment cause associated with priority services, the AMF 140 shall include a Message Priority header to indicate priority information for all subsequent messages. Other NFs relay the priority information by including the Message Priority header in service-based interfaces, as specified in TS 29.500.

Embodiments herein reuse the existing MPS subscription information by the AMF 140 to give priority treatment to MO SMS over NAS in 5GS based on whether the MPS for the SMS is enabled. The subsequent NFs like SMSF 105, SMS-IWMSC 135 shall give priority treatment based on the presence of Message Priority header received from the AMF 140 until the message is reached SMS-SC.

Here the MPS parameter can be configured at the subscription level which means any MO or MT service for the UE 145 will be given priority treatment or at the SMS subscription only which means only applicable to SMS service. In this case when the UE 145 registers and provides SMS supported indication as per TS 23.501, in registration accept, the AMF 140 will provide SMS allowed and MPS for SMS to the UE 145 which will help the UE 145 to provide priority establishment cause to NG-RAN, the AMF 140 while sending MO SMS.

MO SMS over NAS in EPS: The concept is similar to the procedure proposed in 5GS with the below difference, AMF+SMSF is replaced with MME, and the UDM 120 is replaced with the HSS.

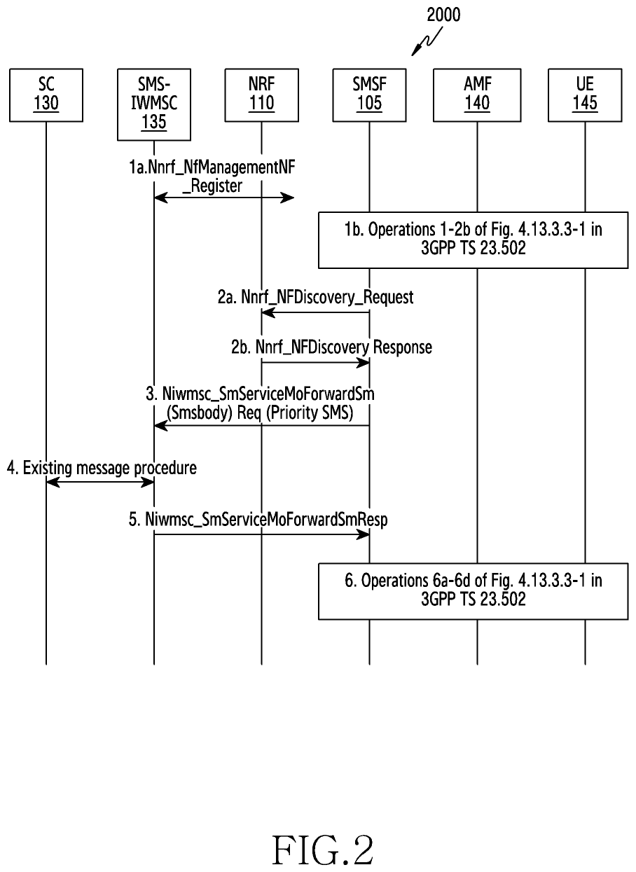

FIG. 2 illustrates the process of managing the MO SMS over NAS in 5GS in a wireless network according to an embodiment of the disclosure.

Referring to FIG. 2, in in a wireless network 2000, in operation 1a, the SMS-IWMSC 135 registers a Niwmsc_SMService service in the NRF 110, during the NF registration procedure. In operation 1b, transfer of the MO SM message from the UE 145 to the SMSF 105 through the AMF 140 follows the current procedure as defined in 3GPP TS 23.040. The AMF 140 shall add the message priority header to the SMSF 105 if the AMF 140 finds an MPS subscription for the SMS is enabled. In operation 2a, if the SMSF 105 knows from a local configuration that the target SMS-IWMSC 135 does not support SBI, it shall quit the SBI-based procedure and fallback to legacy (MAP/Diameter) protocol based procedures, as defined in TS 23.040, or the SMSF 105 invokes the Nnrf_NFDiscovery to discover and select serving SMS-IWMSC 135 with the parameters of SUPI and/or GPSI and/or location (e.g. TAIs, CGIs, etc.) and/or E.164 address of the SC. In operation 2b, if no SMS-IWMSC 135 could be discovered, the NRF 110 shall provide feedback to the SMSF 105, and the SMSF 105 shall quit the SBI-based procedure and fallbacks to legacy (MAP/Diameter) protocol based procedures, as defined in TS 23.040. If a SMS-IWMSC 135 is discovered and selected, the NRF 110 returns the IP addresses or Fully Qualified Domain Names (FQDNs) of the serving SMS-IWMSC 135 to provide Niwmsc_SMService service to SMSF 105. In operation 3, the SMSF 105 sends a Niwmsc_SMService_MoForwardSm service request to the URI of serving SMS-IWMSC 135, which is obtained in operation 2b. The payload body of the request shall contain the SM record to be sent, the Service Centre address, the callbackURI for MO SMS Delivery Report, the timer for waiting the MO SMS Delivery Report, and optionally contains the Access Type. The SMSF 105 shall forward the received Message Priority header from the AMF 140 to SMS-IWMSC 135. The SMSF 105 should add Session-Priority AVP in Diameter protocol instead of forwarding Message Priority header if SMS-IWMSC 135 does not support SBI as per operation 2a.

In operation 4, the MO SMS delivery procedure between the SMS-IWMSC 135 and the SC 130 is the same as the definition in operation 4 of FIG. 4.13.3.3-1 of 3GPP TS 23.502. In operation 5, the SMS-IWMSC 135 sends a Niwmsc_SMService_MoForwardSm response to deliver the MO SMS delivery report to the URI of serving SMSF 105, which is obtained in operation 3. In operation 5, the MO SMS delivery report procedure between (among) the SMSF 105, the AMF 140 and the UE 145 is the same as the 3GPP TS 23.502. When no more SMS is to be sent, the procedure for CP-ack and SMS ack is the same as the 3GPP TS 23.502. These procedures are defined in operations 6a to 6d of FIG. 4.13.3.3-1 of 3GPP TS 23.502.

Here the MPS parameter can be configured at the subscription level which means any MO or MT service for the UE 145 will be given priority treatment or at the SMS subscription only which means only applicable to SMS service. In this case when the UE 145 registers and provides SMS supported indication as per TS 23.501, in registration accept, the AMF 140 will provide SMS allowed and MPS for SMS to the UE 145 which will help UE 145 to provide priority establishment cause to NG-RAN, the AMF 140 while sending MO SMS.

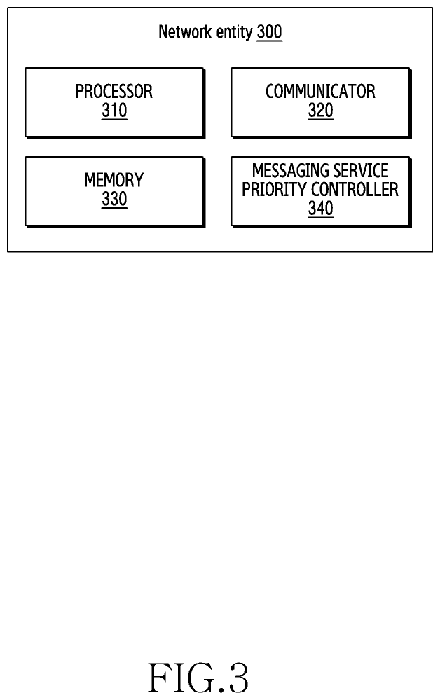

FIG. 3 illustrates various hardware components of a network entity, according to an embodiment of the disclosure.

Referring to FIG. 3, a network entity 300 may be, for example, but not limited to the SMS-GMSC entity 125, the AMF entity 140, and the MME entity. In an embodiment, the network entity 300 includes a processor 310, a communicator 320, memory 330, and a messaging service priority controller 340. The processor 310 is coupled with the communicator 320, the memory 330, and the messaging service priority controller 340.

The messaging service priority controller 340 queries at least one of: the UDM entity 120 and the HSS to determine whether the MPS for a messaging service (e.g., short message service (SMS)) is enabled or not.

In another embodiment, the SMS-GMSC entity 125 queries the at least one of the UDM entity 120 and the HSS entity to determine whether the MPS for the messaging service is enabled for mobile terminating messaging service.

In yet another embodiment, at least one of: the AMF entity 140 and the MME entity queries the at least one of: the UDM entity 120 and the HSS entity to determine whether the MPS for the messaging service is enabled for mobile originating messaging service.

In yet another embodiment, when the network entity 300 is a SMS-GMSC entity 125, the messaging service priority controller 340 receives the message from the SMS-SC entity. Further, the messaging service priority controller 340 queries the UDM entity 120 to determine whether the MPS for the messaging service is enabled based on the message.

In response to determining that the MPS for the messaging service is enabled, the messaging service priority controller 340 adds the message priority header.

In yet another embodiment, the messaging service priority controller 340 adds the message priority header, while sending the message to a SMSF entity 105.

In yet another embodiment, when the network entity 300 is an AMF entity 140, the messaging service priority controller 340 provides a priority messaging service indication in a paging message, when the UE 145 is in a CM-IDLE state and the AMF entity 140 needs to send a messaging service over Third Generation Partnership Project (3GPP) access, and if the UE 145 indicates a paging cause indication for a priority messaging service feature is supported to a wireless network.

In yet another embodiment, all subsequent NFs provide the priority to the messaging service based on the message priority header. All the subsequent NFs includes at least one of: the IP-SM-GW 115, the SMSF entity 105, and the AMF entity 140. All the subsequent NFs relay priority information by including the message priority header in at least one service-based interface

The MPS for the messaging service is valid when at least one of: the MPS priority parameter is set, a User Equipment (UE) is allowed to use a messaging service, an MPS-EPS-Priority bit is set and a parameter indicate whether the MPS for messaging service is enabled or not in at least one of: the UDM entity 120 and the HSS entity.

Further, the messaging service priority controller 340 pages with priority by giving the MPS for a messaging service indication.

The messaging service priority controller 340 is implemented by analog and/or digital circuits such as logic gates, integrated circuits, microprocessors, microcontrollers, memory circuits, passive electronic components, active electronic components, optical components, hardwired circuits and the like, and may optionally be driven by firmware.

The processor 310 may include one or a plurality of processors. The one or the plurality of processors may be a general-purpose processor, such as a central processing unit (CPU), an application processor (AP), or the like, a graphics-only processing unit such as a graphics processing unit (GPU), a visual processing unit (VPU), and/or an AI-dedicated processor such as a neural processing unit (NPU). The processor 310 may include multiple cores and is configured to execute the instructions stored in the memory 330.

Further, the processor 310 is configured to execute instructions stored in the memory 330 and to perform various processes. The communicator 320 is configured for communicating internally between internal hardware components and with external devices via one or more networks. The memory 330 also stores instructions to be executed by the processor 310. The memory 330 may include non-volatile storage elements. Examples of such non-volatile storage elements may include magnetic hard discs, optical discs, floppy discs, flash memories, or forms of electrically programmable memories (EPROM) or electrically erasable and programmable (EEPROM) memories. In addition, the memory 330 may, in some examples, be considered a non-transitory storage medium. The term “non-transitory” may indicate that the storage medium is not embodied in a carrier wave or a propagated signal. However, the term “non-transitory” should not be interpreted that the memory 330 is non-movable. In certain examples, a non-transitory storage medium may store data that can, over time, change (e.g., in Random Access Memory (RAM) or cache).

Although FIG. 3 illustrates various hardware components of the network entity 300 but it is to be understood that other embodiments are not limited thereon. In other embodiments, the network entity 300 may include less or more number of components. Further, the labels or names of the components are used only for illustrative purposes and does not limit the scope of the disclosure. One or more components can be combined together to perform the same or substantially similar function in the network entity 300.

FIG. 4 illustrates various hardware components of the NG-RAN, according to an embodiment of the disclosure.

Referring to FIG. 4, a NG-RAN 400 includes a processor 410, a communicator 420, memory 430, and a messaging service priority controller 440. The processor 410 is coupled with the communicator 420, the memory 430, and the messaging service priority controller 440.

The messaging service priority controller 440 receives the priority messaging service indication in the NGAP paging message from an AMF entity 140. Upon reception of the priority messaging service indication in the NGAP paging message from the AMF entity 140, the messaging service priority controller 440 supports the paging cause indication for the priority messaging service, Further, the messaging service priority controller 440 includes the priority messaging service indication in the paging message to the UE 145.

The NG-RAN 400 uses the priority messaging service indication, while the UE 145 is in one of: a CM-IDLE, CM-CONNECTED state and an RRC-INACTIVE state.

The messaging service priority controller 440 is implemented by analog and/or digital circuits such as logic gates, integrated circuits, microprocessors, microcontrollers, memory circuits, passive electronic components, active electronic components, optical components, hardwired circuits and the like, and may optionally be driven by firmware.

The processor 410 may include one or a plurality of processors. The one or the plurality of processors may be a general-purpose processor, such as a central processing unit (CPU), an application processor (AP), or the like, a graphics-only processing unit such as a graphics processing unit (GPU), a visual processing unit (VPU), and/or an AI-dedicated processor such as a neural processing unit (NPU). The processor 410 may include multiple cores and is configured to execute the instructions stored in the memory 430.

Further, the processor 410 is configured to execute instructions stored in the memory 430 and to perform various processes. The communicator 420 is configured for communicating internally between internal hardware components and with external devices via one or more networks. The memory 430 also stores instructions to be executed by the processor 410. The memory 430 may include non-volatile storage elements. Examples of such non-volatile storage elements may include magnetic hard discs, optical discs, floppy discs, flash memories, or forms of electrically programmable memories (EPROM) or electrically erasable and programmable (EEPROM) memories. In addition, the memory 430 may, in some examples, be considered a non-transitory storage medium. The term “non-transitory” may indicate that the storage medium is not embodied in a carrier wave or a propagated signal. However, the term “non-transitory” should not be interpreted that the memory 430 is non-movable. In certain examples, a non-transitory storage medium may store data that may, over time, change (e.g., in Random Access Memory (RAM) or cache).

Although FIG. 4 illustrates various hardware components of the NG-RAN 400 but it is to be understood that other embodiments are not limited thereon. In other embodiments, the NG-RAN 400 may include less or more number of components. Further, the labels or names of the components are used only for illustrative purposes and does not limit the scope of the disclosure. One or more components can be combined together to perform the same or substantially similar function in the NG-RAN 400.

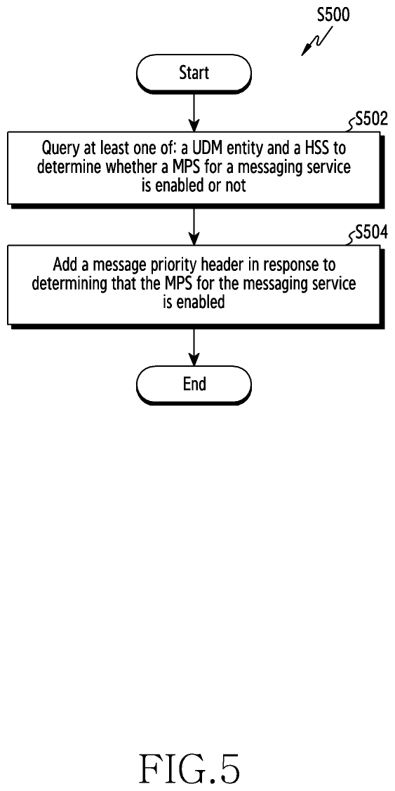

FIG. 5 is a flow chart illustrating a method for providing a priority service to a messaging service in the wireless network by a network entity, according to an embodiment of the disclosure.

Referring to FIG. 5, in a method S500, operations S502-S504 are handled by the messaging service priority controller 340.

At operation S502, the method includes querying the at least one of: the UDM entity 120 and the HSS to determine whether the MPS for the messaging service is enabled or not. At operation S504, the method includes adding the message priority header in response to determining that the MPS for the messaging service is enabled.

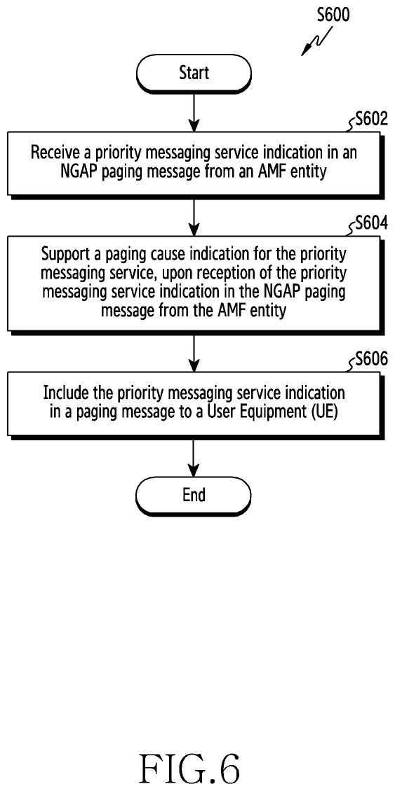

FIG. 6 is a flow chart illustrating a method for providing a priority service to a messaging service in a wireless network by a NG-RAN, according to an embodiment of the disclosure.

Referring to FIG. 6, in a method S600, operations S602-S606 are handled by the messaging service priority controller 440.

At operation S602, the method includes receiving the priority messaging service indication in the NGAP paging message from the AMF entity 140. At operation S604, the method includes supporting the paging cause indication for the priority messaging service, upon reception of the priority messaging service indication in the NGAP paging message from the AMF entity 140. At operation S606, the method includes including the priority messaging service indication in a paging message to the UE 145.

Based on the proposed method, when the network is congested then, there is a need for giving priority treatment to services which is critical in nature similar to the emergency service, otherwise the services won't be received by user. Based on the proposed method, the messaging service or SMS needs to be prioritized, so as to improve the user experience.

The various actions, acts, blocks, steps, operations or the like in the flow charts at operations S500-S600 may be performed in the order presented, in a different order or simultaneously. Further, in some embodiments, some of the actions, acts, blocks, steps, operations or the like may be omitted, added, modified, skipped, or the like without departing from the scope of the disclosure.

The embodiments disclosed herein can be implemented through at least one software program running on at least one hardware device and performing network management functions to control the network elements. The elements include blocks which can be at least one of a hardware device, or a combination of hardware device and software module.

The embodiment disclosed herein describes systems and methods for ensuring that the 5G system is able to provide MPS to specific services (such as, but not limited to, SMS over 5GS and EPS). Therefore, it is understood that the scope of the protection is extended to such a program and in addition to a computer readable means having a message therein, such computer readable storage means contain program code means for implementation of one or more operations of the method, when the program runs on a server or mobile device or any suitable programmable device. The method is implemented in at least one embodiment through or together with a software program written in e.g., Very high speed integrated circuit Hardware Description Language (VHDL) another programming language, or implemented by one or more VHDL or several software modules being executed on at least one hardware device. The hardware device can be any kind of portable device that can be programmed. The device may also include means which could be e.g., hardware means like e.g., an ASIC, or a combination of hardware and software means, e.g. an ASIC and an FPGA, or at least one microprocessor and memory with software modules located therein. The method embodiments described herein could be implemented partly in hardware and partly in software. Alternatively, the disclosure may be implemented on different hardware devices, e.g., using a plurality of CPUs.

While the disclosure has been shown and described with reference to various embodiments thereof, it will be understood by those skilled in the art will that various changes in form and details may be made therein without departing from the spirit and scope of the disclosure as defined by the appended claims and their equivalents.

What is claimed is:

1. A method performed by a network entity in a wireless communication system, the method comprising:
querying, by the network entity, at least one of a Unified Data Management (UDM) entity and a Home Subscriber Server (HSS) entity to determine whether a Multimedia Priority Service (MPS) for a messaging service is enabled; and
adding, by the network entity, a message priority header in response to determining that the MPS for the messaging service is enabled.

2. The method of claim 1,
wherein all subsequent network functions (NFs) provide a priority to the messaging service based on the message priority header,
wherein all the subsequent NFs relay priority information by including the message priority header in at least one service-based interface,
wherein all the subsequent NFs comprises at least one of:
an Internet Protocol Short Message Gateway (IP-SM-GW),
a Short Message Service Function (SMSF) entity, or
an Access and Mobility Management Function (AMF) entity, and
wherein the messaging service comprises a short message service (SMS).

3. The method of claim 1, wherein the network entity comprises at least one of:
a Short Message Service Gateway Mobile Switching Center (SMS-GMSC) entity;
Access and Mobility Management Function (AMF) entity; or
a Mobility Management Entity (MME) entity.

4. The method of claim 3, wherein the SMS-GMSC entity queries the at least one of the UDM entity or the HSS entity to determine whether the MPS for the messaging service is enabled for mobile terminating messaging service.

5. The method of claim 3, wherein at least one of: the AMF entity or the MME entity queries the at least one of the UDM entity or the HSS entity to determine whether the MPS for the messaging service is enabled for mobile originating messaging service.

6. The method of claim 5, wherein the method comprises adding the message priority header.

7. The method of claim 1, wherein the MPS for the messaging service is valid when at least one of:
a MPS priority parameter is set;
a user equipment (UE) is allowed to use a messaging service; or
an MPS-Evolved Packet System (EPS)-Priority bit is set and a parameter indicate whether the MPS for messaging service is enabled in at least one of the UDM entity and the HSS entity.

8. The method of claim 1, wherein, based on the network entity being an AMF entity, adding the message priority header comprises:
providing a priority messaging service indication in a paging message, when a User Equipment (UE) is in a CM-IDLE state and the AMF entity needs to send a messaging service over Third Generation Partnership Project (3GPP) access, and based on the UE indicating a paging cause indication for a priority messaging service feature is supported to a wireless network.

9. A network entity in a wireless communication system, the network entity comprising:
a transceiver; and
at least one controller coupled with the transceiver, wherein the controller is configured to:
query at least one of a Unified Data Management (UDM) entity and a Home Subscriber Server (HSS) entity to determine whether a Multimedia Priority Service (MPS) for a messaging service is enabled, and
add a message priority header in response to determining that the MPS for the messaging service is enabled.

10. The network entity of claim 9,
wherein all subsequent network functions (NFs) provide a priority to the messaging service based on the message priority header,
wherein all the subsequent NFs relay priority information by including the message priority header in at least one service-based interface,
wherein all the subsequent NFs comprises at least one of:
an Internet Protocol Short Message Gateway (IP-SM-GW),
a Short Message Service Function (SMSF) entity, or
an Access and Mobility Management Function (AMF) entity, and
wherein the messaging service comprises a short message service (SMS).

11. The network entity of claim 9, wherein the network entity comprises at least one of:
a Short Message Service Gateway Mobile Switching Center (SMS-GMSC) entity;
Access and Mobility Management Function (AMF) entity; or
a Mobility Management Entity (MME) entity.

12. The network entity of claim 11, wherein the SMS-GMSC entity queries the at least one of the UDM entity or the HSS entity to determine whether the MPS for the messaging service is enabled for mobile terminating messaging service.

13. The network entity of claim 12, wherein at least one of the AMF entity or the MME entity queries the at least one of the UDM entity or the HSS entity to determine whether the MPS for the messaging service is enabled for mobile originating messaging service.

14. The network entity of claim 9, wherein the at least one controller is further configured to add the message priority header.

15. The network entity of claim 9, wherein the MPS for the messaging service is valid when at least one of:
a MPS priority parameter is set;
a user equipment (UE) is allowed to use a messaging service;
an MPS-Evolved Packet System (EPS)-Priority bit is set; and
a parameter indicate whether the MPS for messaging service is enabled in at least one of the UDM entity and the HSS entity.

16. The network entity of claim 9, wherein, based on the network entity being an AMF entity, the controller is further configured to:
provide a priority messaging service indication in a paging message, when a User Equipment (UE) is in a CM-IDLE state and the AMF entity needs to send a messaging service over Third Generation Partnership Project (3GPP) access, and based on the UE indicating a paging cause indication for a priority messaging service feature is supported to a wireless network.

17. A method performed by a base station (BS) in a wireless communication system, the method comprising:
receiving, by the BS from an Access and Mobility Management Function (AMF) entity, a priority messaging service indication in a next generation application protocol (NGAP) paging message;
supporting, by the BS, a paging cause indication for the priority messaging service, upon reception of the priority messaging service indication in the NGAP paging message from the AMF entity; and
including, by the BS, the priority messaging service indication in a paging message to a user equipment (UE).

18. The method of claim 17, wherein the BS uses the priority messaging service indication, while the UE is in one of:
a connection management (CM)-IDLE;
CM-CONNECTED state; or
a Radio Resource Control (RRC)-INACTIVE state.

19. A base station (BS), the base station comprising:
a transceiver; and
at least one controller coupled with the transceiver, wherein the controller is configured to:
receive, from an Access and Mobility Management Function (AMF) entity, an indication of a priority messaging service in a next generation application protocol (NGAP) paging message,
support a paging cause indication for the priority messaging service, upon reception of the priority messaging service indication in the NGAP paging message from the AMF entity, and
include the priority messaging service indication in a paging message to a user equipment (UE).

20. The BS of claim 19, wherein the BS uses the priority messaging service indication, while the UE is in one of:
a connection management (CM)-IDLE;
CM-CONNECTED state; or
a Radio Resource Control (RRC)-INACTIVE state.
